(19) United States
(12) Patent Application Publication
(10) Pub. No.: US 2024/0177251 A1
(43) Pub. Date: May 30, 2024

(54) PRODUCTION TASK SCHEDULING METHOD, SYSTEM AND DEVICE FOR FLEXIBLE ASSEMBLY JOB SHOP

(71) Applicant: Henan University of Science and Technology, Luoyang (CN)

(72) Inventors: Qingtao WU, Luoyang (CN); Chenlu ZHANG, Luoyang (CN); Mingchuan ZHANG, Luoyang (CN); Ruijuan ZHENG, Luoyang (CN); Xuhui ZHAO, Luoyang (CN); Junlong ZHU, Luoyang (CN); Zhihang JI, Luoyang (CN); Muhua LIU, Luoyang (CN)

(21) Appl. No.: 18/156,533

(22) Filed: Jan. 19, 2023

(30) Foreign Application Priority Data
Nov. 23, 2022 (CN) 202211477025.1

(51) Int. Cl. G06Q 50/04; G06F 17/18; G06Q 10/04; G06Q 10/0631

(52) U.S. Cl. CPC G06Q 50/04; G06F 17/18; G06Q 10/04; G06Q 10/063116

(57) ABSTRACT

A production task scheduling method, system and device for a flexible assembly job shop is provided. The method includes: compiling production processing data in a double-layer integer coding manner to obtain a double-layer code scheme; sorting lower-layer codes in the double-layer code scheme to generate an initialized population; calculating a fitness value of each individual in the population, selecting a solution with an optimal fitness value as an elite individual, and replicating the elite individual to construct an elite matrix; constructing an external archive; selecting an excellent individual from all non-dominant solutions stored in the external archive as an optimal elite individual by using a simulated annealing algorithm, and updating the elite matrix through the optimal elite individual; determining a final optimal elite individual as an optimal scheduling scheme based on an updated elitist matrix through using a three-stage heuristic optimization algorithm with multi-search fusion in an iterative process.

### CROSS-REFERENCE TO RELATED APPLICATION

This patent application claims the benefit and priority of Chinese Patent Application No. 202211477025.1 filed with the China National Intellectual Property Administration on Nov. 23, 2022, the disclosure of which is incorporated by reference herein in its entirety as part of the present application.

### TECHNICAL FIELD

The present disclosure relates to the technical field of shop scheduling management, in particular to a production task scheduling method, system and device for a flexible assembly job shop.

### BACKGROUND

With the continuous improvement of informationization level of traditional manufacturing enterprises, a traditional production shop is gradually striding towards automation and intelligentization. However, a task scheduling problem in a production shop essentially belongs to the field of shop scheduling management, and is precisely called a Flexible Job Shop Scheduling Problem (FJSP).

The Flexible Job Shop Scheduling problem consists of two sub-problems: machine assignment, which selects one device for each procedure from a set of device candidates; and procedure sequencing, which schedules all procedures on all devices to obtain a satisfactory production plan. This is one of the most critical problems in production planning and manufacture managing of the manufacturing enterprises. The FJSP problem is very complex and has now been proved to be an NP-Hard problem. Because of the complexity of this problem, it is difficult to be solved in a reasonable time by using a traditional mathematical optimization method.

A Flexible Assembly Job Shop (FAJS) further considers an assembly association constraint of parts on the basis of Job Shop Scheduling (JSP). The FAJS is a common shop type in equipment manufacturing enterprises. Parts with different paths and working hours are machined separately, and associated parts that are to be assembled can be assembled only after being machined. Compared with JSP, a production schedule of associated parts which are collaboratively assembled in FAJS production is a key of production scheduling. This is because the associated parts enter an assembly shop as simultaneously as possible, which can reduce the assembly waiting time of the associated parts, and help to give the production capacity to the urgent parts, thereby improving the production efficiency of the shop.

At present, a solution to the task scheduling problem in such a production shop will simplify the production process restrictions and constraints for a specific unit, and ignore preparation time before a device is put into production, such as preparation time of production raw materials, and time that a worker spends on loading, unloading and cleaning a machine. In addition, based on problems of an assembly procedure, a complete assembly method is usually adopted, that is, the assembly work can be started only after all the parts in the product order have been processed, which is not completely applicable to the actual production task with large scale of the process flow. Further, most of these problems rely on production management personnel to make decisions according to accumulated experience, while manual scheduling has problems such as low efficiency, difficult resource optimization and low allocation and utilization. Therefore, for manufacturing enterprises, it is of great practical significance to establish a scientific production planning and deeply study a scheduling model and solve it effectively.

### SUMMARY

An objective of some embodiments of the present disclosure is to provide a production task scheduling method, system and device for a flexible assembly job shop, so as to optimize a scheduling process for a flexible assembly shop and improve a scheduling efficiency for a manufacturing shop.

To achieve the above objective, the present disclosure adopts the following technical solutions.

A production task scheduling method for a flexible assembly job shop, including:
compiling production processing data in a double-layer integer coding manner to obtain a double-layer code scheme, where upper-layer codes in the double-layer code scheme include a process type corresponding to workpiece machining and an assembly process constraint relationship, and lower-layer codes in the double-layer code scheme include machine assignment and procedure sequencing;
sorting the lower-layer codes to generate an initialized population, where individuals in the initialized population all follow the assembly process constraint relationship;
calculating a fitness value of each individual in the population, selecting a solution with an optimal fitness value as an elite individual, and replicating the elite individual to construct an elite matrix;
constructing an external archive, where the external archive is used to store currently found non-dominant solutions;
selecting an excellent individual from all non-dominant solutions stored in the external archive as an optimal elite individual by using a simulated annealing algorithm, and updating the elite matrix through the optimal elite individual;
determining a final optimal elite individual as an optimal scheduling scheme based on an updated elitist matrix through using a three-stage heuristic optimization algorithm with multi-search fusion in an iterative process;
scheduling production tasks in a flexible assembly job shop according to the optimal scheduling scheme.

Optionally, the lower-layer codes are sorted by a method combining global selection, local selection and random selection to generate the initialized population.

Optionally, after constructing the external archive, the method further includes:
when the external archive is determined to be overflowing, calculating crowding densities of the non-dominant solutions in the external archive, and replacing a non-dominant optimal solution with a highest crowding density through using a roulette algorithm.

Optionally, at an initial stage of an iteration, the population is updated by Brown motion; at an intermediate stage of the iteration, a first half of the population is updated by Levy motion, and a second half of the population is updated by the Brown motion; at a final stage of the iteration, the population is updated by the Levy motion.

Optionally, the method further includes adding a Gaussian disturbance in the iterative process.

The present disclosure further provides a production task scheduling system for a flexible assembly job shop, including:
a compiling module, configured for compiling production processing data in a double-layer integer coding manner to obtain a double-layer code scheme, where upper-layer codes in the double-layer code scheme include a process type corresponding to workpiece machining and an assembly process constraint relationship, and lower-layer codes in the double-layer code scheme include machine assignment and procedure sequencing;
a sorting module, configured for sorting the lower-layer codes to generate an initialized population;
an elite matrix constructing module, configured for calculating a fitness value calculation of individuals in the population, selecting a solution with an optimal fitness value as an elite individual, and replicating the elite individual to construct an elite matrix;
an external archive constructing module, configured for constructing an external archive, where the external archive is used to store currently found non-dominant solutions;
an updating module, configured for selecting an excellent individual from all non-dominant solutions stored in the external archive as an optimal elite individual by using a simulated annealing algorithm, and updating the elite matrix through the optimal elite individual;
an optimal scheduling scheme determining module, configured for determining a final optimal elite individual as an optimal scheduling scheme based on an updated elitist matrix through using a three-stage heuristic optimization algorithm with multi-search fusion in an iterative process;
a task scheduling module, configured for scheduling production tasks in a flexible assembly job shop according to the optimal scheduling scheme.

The present disclosure further provides an electronic device including a memory for storing a computer program and a processor for executing the computer program to cause the electronic device to perform the production task scheduling method as described above.

The present disclosure further provides a computer-readable storage medium storing a computer program that, when executed by a processor, implements the production task scheduling method as described above.

According to specific embodiments of the present disclosure, the following technical effects are disclosed.

The present disclosure provides a production task scheduling method for a flexible assembly job shop, including: compiling production processing data in a double-layer integer coding manner to obtain a double-layer code scheme; sorting lower-layer codes in the double-layer code scheme to generate an initialized population; calculating a fitness value of each individual in the population, selecting a solution with an optimal fitness value as an elite individual, and replicating the elite individual to construct an elite matrix; constructing an external archive; selecting an excellent individual from all non-dominant solutions stored in the external archive as an optimal elite individual by using a simulated annealing algorithm, and updating the elite matrix through the optimal elite individual; determining a final optimal elite individual as an optimal scheduling scheme based on an updated elitist matrix through using a three-stage heuristic optimization algorithm with multi-search fusion in an iterative process. The present disclosure adds a strong process level constraint relationship based on production tasks of a traditional flexible job shop. Only after a low constraint level task is completed, a next level task can be processed. Therefore, the present disclosure can be used in complex production scenarios with small batch, customization, complex production process and strong process constraint relationship, and the production efficiency is improved while the stability of the construction period is ensured.

### BRIEF DESCRIPTION OF THE DRAWINGS

To describe the technical solutions in embodiments of the present disclosure or in the prior art more clearly, the accompanying drawings required in the embodiments are briefly described below. Apparently, the accompanying drawings in the following description show merely some embodiments of the present disclosure, and other drawings can be derived from these accompanying drawings by those of ordinary skill in the art without creative efforts.

FIG. 1 is a flowchart of a production task scheduling method for a flexible assembly job shop according to the present disclosure;

FIG. 2 is another flowchart of a production task scheduling method for a flexible assembly job shop according to the present disclosure;

FIG. 3 is a schematic diagram of a double-layer code scheme according to the present disclosure;

FIG. 4 is a Gantt chart of a scheduling scheme according to the present disclosure.

### DETAILED DESCRIPTION OF THE EMBODIMENTS

The technical solutions in the embodiments of the present disclosure will be described below clearly and completely with reference to the accompanying drawings in the embodiments of the present disclosure. Apparently, the described embodiments are merely some rather than all of the embodiments of the present disclosure. All other embodiments obtained by those of ordinary skill in the art based on the embodiments of the present disclosure without making creative efforts shall fall within the protection scope of the present disclosure.

An objective of some embodiments of the present disclosure is to provide a production task scheduling method, system and device for a flexible assembly job shop, so as to optimize a scheduling process for a flexible assembly shop and improve a scheduling efficiency for a manufacturing shop.

To make the above-mentioned objective, features, and advantages of the present disclosure clearer and more comprehensible, the present disclosure will be further described in detail below in conjunction with the accompanying drawings and specific embodiments.

### Embodiment 1

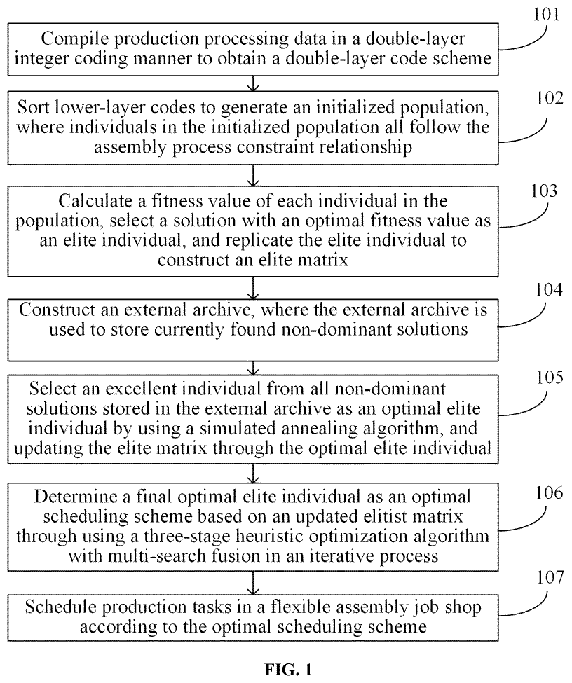

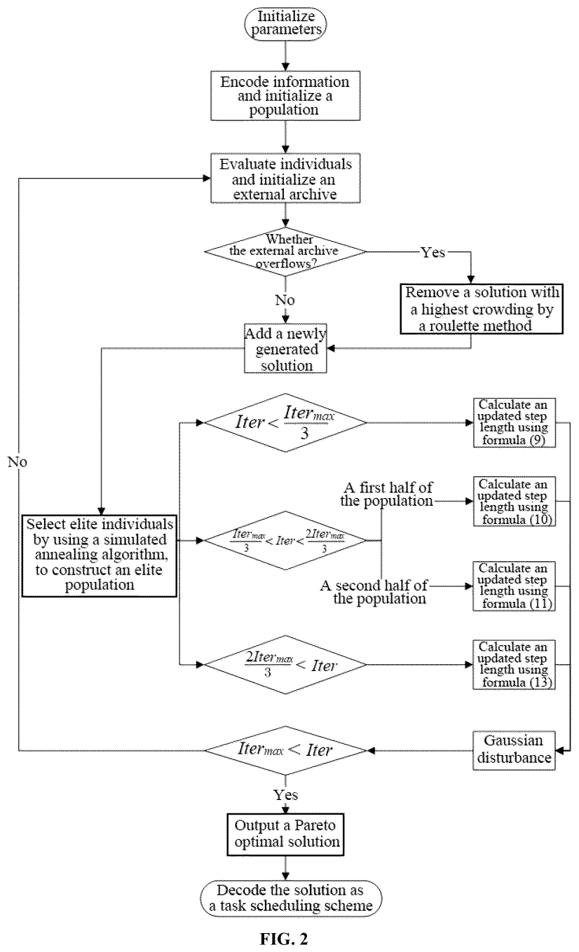

As shown in FIGS. 1-2, the embodiment provides a production task scheduling method for a flexible assembly job shop, including the following steps 101-107.

In step 101, production processing data is compiled in a double-layer integer coding manner to obtain a double-layer code scheme, where upper-layer codes in the double-layer code scheme include a process type corresponding to workpiece machining and an assembly process constraint relationship, and lower-layer codes in the double-layer code scheme include machine assignment and procedure sequencing.

In step 102, the lower-layer codes are sorted to generate an initialized population, where individuals in the initialized population all follow the assembly process constraint relationship.

In step 103, a fitness value of each individual in the population is calculated, a solution with an optimal fitness value is selected as an elite individual, and the elite individual is replicated to construct an elite matrix.

In step 104, an external archive is constructed, where the external archive is used to store currently found non-dominant solutions.

In step 105, by using a simulated annealing algorithm, an excellent individual is selected from all non-dominant solutions stored in the external archive as an optimal elite individual, and the elite matrix is updated through the optimal elite individual.

In step 106, based on an updated elitist matrix, a final optimal elite individual is determined as an optimal scheduling scheme through using a three-stage heuristic optimization algorithm with multi-search fusion in an iterative process.

In step 107, production tasks in a flexible assembly job shop are scheduled according to the optimal scheduling scheme.

Step 101 specifically includes as follows.
(1) Shop production processing data is inputted, and algorithm parameters are initialized.

A scheduling problem in the flexible assembly job shop can be described as follows: n workpieces a (J₁, J₂, . . . Jₙ) are to be machined or assembled on m machines (M₁, M₂, . . . Mₘ) . O_{i,j} represents a j-th procedure of a workpiece i, each workpiece has one or more procedures, a sequence of the procedures is predetermined, and a total number of procedures is T₀. There is a priority constraint relationship between workpieces and procedures. A machine shall be prepared for device cleaning, unloading and loading before production. If two adjacent procedures on a same machine are processing procedures for a same workpiece, intermediate preparation time can be ignored.

Inputted production processing data includes: types and quantities of production workpieces; production processing process flow and priority relationship of each workpiece; processing time and processing preparation time for constructing a two-dimensional time matrix P_{table}; quantities and types of machines and devices available for production processing.

Initialized algorithm parameters include: a number N of individuals in the population, a size N/2 of the external archive, a maximum number of iterations Iterₘₐₓ of the algorithm, a global selection probability C₁, a local selection probability C₂, a random selection probability C₃, an initial temperature T for setting the simulated annealing parameters, an attenuation factor γ and a Gaussian disturbance probability G.

A production process is based on the following instructions:
1) The time when raw material required to produce a workpiece J can be put into production is regarded as arrival time of an order.
2) Each device can only process one task at the same time. Once the device starts, preemption is not allowed. And the same job can only be processed by one machine at the same time.
3) A constraint level describes strict job constraints. The constraint level is calculated by adding 1 to the constraint level value of all previous jobs. A job constraint level without procedure constraint is 1.
4) Transportation time of parts and materials is not considered, because the transportation time is smaller than the processing time of the parts, a transportation cost is small, and there is no insufficient transportation capacity.
(2) Individuals are coded, and the population is initialized.

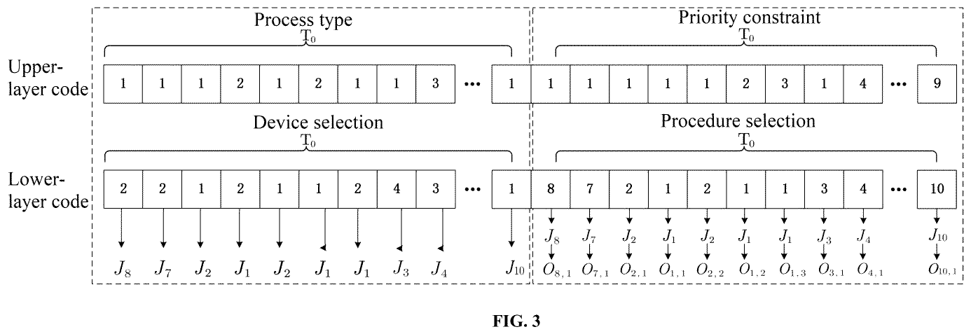

The present disclosure compiles the production processing data in a double-layer integer coding manner to obtain a double-layer code scheme, and constitutes a shop scheduling sequence, such that location update of an algorithm population can be directly carried out in discrete space. The lower-layer codes consist of machine assignment and procedure sequencing, with a length of 2T₀. The upper-layer codes correspond to the lower-layer codes bit by bit, and a first half corresponds to a second half bit by bit, as shown in FIG. 3.

The coding sequence is compiled from bottom to top and from left to right. A device selection portion in the lower-layer codes is sorted according to the order of the workpieces and workpiece procedures in turn, and each integer bit represents a sequential number of a processing machine selected in a current procedure in a set of optional machines. A sequencing portion of a latter procedure is directly coded by a serial number of the workpiece, which indicates a sequence of processing. The first half in the upper-layer codes stores the process type label corresponding to workpiece machining, and the second half stores priorities of procedures. Under the same process route, the priorities are strictly arranged according to the grade. For example, a first bit code in the lower-layer codes of FIG. 3 should be interpreted as follows: the serial number thereof corresponds to No. 1 procedure operation of No. 8 task in No. 1 production process route, and the second machine is selected for processing in the available device set, and the operation priority thereof is level 1.

Table 1 shows a production example of a flexible assembly shop. The example includes a set of process routes, containing 10 workpieces. There are 55 procedures in total, including ordinary processing and assembly operations. The coding length of the double-layer scheduling sequence generated by the example is 110. Production device resources are 4 computer numerical control (CNC) machine tools M₁, M₂, M₃ and M₄, and 2 assembly machine tools M₅ and M₆. This production example is a scheduling problem in a flexible assembly shop with assembly constraints and device preparation time.

TABLE 1
Production Example of Flexible Assembly shop

| | | device processing time/ | | | | | |
|---|---|---|---|---|---|---|---|
| workpiece/ | workpiece/ | device preparation time | | | | | |
| priority | priority | M₁ | M₂ | M₃ | M₄ | M₅ | M₆ |
| J₁/1 | O_{1, 1}/1 | 5/1 | — | 4/2 | — | — | — |
| | O_{1, 2}/1 | — | 1/1 | 5/3 | — | — | — |
| | O_{1, 3}/1 | — | — | 4/4 | — | — | — |
| | O_{1, 4}/1 | 1/1 | 6/4 | — | — | — | — |
| | O_{1, 5}/1 | — | — | 1/3 | 3/1 | — | — |
| | O_{1, 6}/2 | — | — | — | — | 12/5 | 16/8 |
| J₂/1 | O_{2, 1}/1 | — | 6/4 | — | — | — | — |
| | O_{2, 2}/1 | — | — | 1/1 | — | — | — |
| | O_{2, 3}/1 | 2/1 | — | — | 5/3 | — | — |
| | O_{2, 4}/1 | — | 6/1 | — | 6/1 | — | — |
| | O_{2, 5}/1 | 1/1 | 6/5 | — | — | — | — |
| J₃/1 | O_{3, 1}/1 | — | 6/4 | — | — | — | — |
| | O_{3, 2}/2 | — | — | — | — | 14/8 | 22/4 |
| | O_{3, 3}/3 | 1/1 | 6/4 | — | 5/1 | — | — |
| | O_{3, 4}/3 | — | 6/1 | 4/1 | — | — | — |
| | O_{3, 5}/4 | — | — | — | — | 5/5 | 16/4 |
| J₄/2 | O_{4, 1}/1 | 1/1 | 6/6 | — | — | — | — |
| | O_{4, 2}/1 | — | 6/4 | — | 5/5 | — | — |
| | O_{4, 3}/1 | — | — | 1/1 | 1/1 | — | — |
| | O_{4, 4}/1 | — | 1/1 | 5/3 | — | — | — |
| | O_{4, 5}/2 | — | — | 4/3 | 2/1 | — | — |
| J₅/2 | O_{5, 1}/1 | — | 1/1 | 5/5 | — | — | — |
| | O_{5, 2}/1 | 1/1 | 6/3 | — | — | — | — |
| | O_{5, 3}/2 | — | — | — | — | 22/8 | 22/8 |
| | O_{5, 4}/3 | 5/4 | — | 4/2 | — | — | — |
| | O_{5, 5}/3 | — | 6/4 | — | 6/4 | — | — |
| | O_{5, 6}/3 | — | 6/2 | 4/3 | — | — | — |
| J₆/2 | O_{6, 1}/1 | — | — | — | — | 2/8 | 5/5 |
| | O_{6, 2}/2 | 2/1 | — | — | — | — | — |
| | O_{6, 3}/2 | — | 6/3 | 4/4 | — | — | — |
| | O_{6, 4}/2 | — | 6/1 | — | — | — | — |
| | O_{6, 5}/2 | 1/1 | 6/1 | — | — | — | — |
| | O_{6, 6}/2 | 3/2 | — | — | 2/1 | — | — |
| J₇/2 | O_{7, 1}/1 | — | — | — | — | — | 10/5 |
| | O_{7, 2}/2 | 3/1 | — | — | 2/2 | — | — |
| | O_{7, 3}/2 | — | 6/3 | 4/4 | — | — | — |
| | O_{7, 4}/2 | 6/1 | 6/2 | — | — | — | — |
| | O_{7, 5}/3 | — | — | — | — | 10/5 | 22/8 |
| J₈/3 | O_{8, 1}/1 | 2/1 | — | 4/1 | — | — | — |
| | O_{8, 2}/1 | — | 6/6 | 4/1 | — | — | — |
| | O_{8, 3}/1 | 1/1 | 6/3 | — | — | — | — |
| | O_{8, 4}/2 | — | — | — | — | 8/5 | 6/4 |
| | O_{8, 5}/3 | — | 6/4 | — | 6/2 | — | — |
| J₉/3 | O_{9, 1}/1 | 2/1 | — | 1/1 | — | — | — |
| | O_{9, 2}/1 | 1/1 | — | — | 5/1 | — | — |
| | O_{9, 3}/1 | — | — | 6/2 | 3/1 | — | — |
| | O_{9, 4}/1 | 2/1 | — | — | — | — | — |
| | O_{9, 5}/2 | — | — | — | — | 24/4 | 16/5 |
| | O_{9, 6}/3 | — | 6/4 | — | 6/4 | — | — |
| J₁₀/3 | O_{10, 1}/1 | — | — | 4/1 | 2/1 | — | — |
| | O_{10, 2}/2 | — | — | — | — | — | 26/2 |
| | O_{10, 3}/2 | — | — | — | — | 23/2 | 25/5 |
| | O_{10, 4}/2 | — | — | — | — | 15/2 | 21/1 |
| | O_{10, 5}/3 | — | 6/4 | — | 6/2 | — | — |
| | O_{10, 6}/3 | 3/3 | — | — | 2/2 | — | — |

Step 102 specifically includes as follows.

The lower-layer codes are sorted by using a method combining global selection (GS), local selection (LS) and random selection (RS) to generate the initialized population.

An algorithm is initialized by using a method combining global selection (GS), local selection (LS), and random selection (RS) to produce a high-quality initial solution \vec{X}₀:

\vec{X}₀=GS*C₁+LS*C₂+RS*C₃ (1)

where a global selection probability C₁=0.6, a local selection probability C₂=0.2, and a random selection probability C₃=0.2 are set. In a search process of the algorithm, the generated solutions strictly follow the procedure constraint principle in the upper-layer code. Under the same production process route, a high-priority task cannot be earlier than a low-priority task. If the low-priority task is detected to be delayed, all the corresponding gene loci are pre-positioned to a preposition of the high-priority task in the same production process route.

The generated initial solution constitutes a population matrix as shown in the following formula (2). X represents a j-th dimension of an i-th initial solution, N is a predetermined number of initial solutions, D represents a predetermined number of objective functions.

$$P = {[ \begin{matrix}{X}_{1 , 1} & {X}_{1 , 2} & … & {X}_{1 , D} \\ {X}_{2 , 1} & {X}_{2 , 2} & … & {X}_{2 , D} \\ {X}_{3 , 1} & {X}_{3 , 2} & … & {X}_{3 , D} \\ ⋮ & ⋮ & ⋮ & ⋮ \\ ⋮ & ⋮ & ⋮ & ⋮ \\ {X}_{N , 1} & {X}_{N , 2} & … & {X}_{N , D}\end{matrix} ]}_{N \times D} \qquad ( 2 )$$

Step 103 specifically includes as follows.

The objective functions are set according to the actual production problem, and individual objective function values (i.e. fitness values) are calculated. The objective functions are set as follows:
(1) An objective function of a maximum completion time is:

$${f}_{1} = min ( {max}_{1 ⩽ j ⩽ n} ( {C}_{j} ) ) \qquad ( 3 )$$

(2) An objective function of a minimum device preparation time is:

$${f}_{2} = min ( {\sum }_{i = 1}^{m} {\sum }_{j = 1}^{n} {\sum }_{h = 1}^{{h}_{j}} {Set}_{ijh} {X}_{ijh} ) \qquad ( 4 )$$

(3) An objective function of a minimum processing waiting time is:

$${f}_{3} = min ( {\sum }_{j = 1}^{n} {wait}_{j} ) \qquad ( 5 )$$

where f₁ is processing completion time of a last procedure of the production task, Cⱼ is completion time of a workpiece j; f₂ is a sum of preparation time before production of all machines in a whole production process, Setᵢⱼₕ is preparation time of a h-th procedure of the workpiece j on a machine i, Xᵢⱼₕ is a decision variable. If a procedure Oⱼₕ is on the device i, a value thereof is 1, otherwise, a value thereof is 0; f₃ is minimum processing waiting time, wait is waiting time before assembly of the workpiece j. Minimizing waitⱼ can reduce the influence of production process constraints and assign production resources reasonably. After that, the calculation of the objective function value is involved, and the calculation is performed according to the above three functions.

An individual in the population with the highest value of the objective function is selected as the elite solution , and an elite matrix Elite is constructed by replicating the individual to guide the population update:

$$Elite = {[ \begin{matrix}{X}_{1 , 1}^{I} & {X}_{1 , 2}^{I} & … & {X}_{1 , D}^{I} \\ {X}_{2 , 1}^{I} & {X}_{2 , 2}^{I} & … & {X}_{2 , D}^{I} \\ ⋮ & ⋮ & ⋮ & ⋮ \\ ⋮ & ⋮ & ⋮ & ⋮ \\ ⋮ & ⋮ & ⋮ & ⋮ \\ {X}_{N , 1}^{I} & {X}_{N , 2}^{I} & … & {X}_{N , D}^{I}\end{matrix} ]}_{N \times D} . \qquad ( 6 )$$

Step 104 specifically includes as follows.

An archive storage mechanism is introduced to store non-dominant solutions found in the iterative updating process of the algorithm, thereby guiding the algorithm to search towards the global optimal direction faster and getting away from the local optimal in the search area better. The update rules are as follows:

A capacity of the external archive is set to be N/2, such that if the solution generated by the population update is dominated by at least one solution in the archive, the archive update is not performed; if the solution generated by the population update dominates one or more solutions in the archive, the old solution is replaced with a newly generated solution; if the solution generated after the population update is not dominated by any solution in the existing archive, the newly generated solution will also be added to the archive.

In addition, if the storage capacity of the archive is exceeded in the process of updating the archive, a crowding density method is used to calculate crowding densities by calculating crowding distances of solutions in the archive, and the solutions with high density are deleted to keep the distribution of the population. The crowding distances of individuals in the population are calculated as follows:

$${d}_{i} = {\sum }_{j = 1}^{r} ( \vert {d}_{i + 1} \cdot {f}_{j} - {d}_{i - 1} \cdot {f}_{j} \vert ) \qquad ( 7 )$$

where dᵢ is a crowding distance of an individual i and dᵢ·fⱼ is a function value of the individual i on a sub-target fⱼ.

After calculating the crowding densities of the individuals, the solutions in the archive are sequenced according to the densities, and the solution with the highest density value is selected so as to be deleted. If multiple solutions with the same density appear, a solution is selected by the roulette wheel selection so as to be deleted from the archive, and a newly generated solution is stored in the archive.

Step 105 specifically includes as follows.

In the archive storage stage, the non-dominant solutions found so far are stored. Therefore, excellent individuals will be selected from the archive as population elites, and function values of non-dominant solutions in the archive will be calculated. An individual with a smallest objective function value is selected in the individuals. If a smallest objective function value of all individuals is smaller than an objective function value of a parent elite individual, the elite individual becomes a latest elite individual, and the elite matrix is updated. Conversely, a simulated annealing algorithm is used to select an individual with a certain probability according to the Metropolis criterion, that is, if

$${e}^{- \frac{y - {y}_{t}}{T}} > rand ,$$

the individual is selected to be a new elite individual, where rand is a random number between [0,1), yₜ is a current state, and y is a new state. The updated elite matrix is as follows:

$${Elite}^{′} = {[ \begin{matrix}{X}_{1 , 1}^{′} & {X}_{1 , 2}^{′} & … & {X}_{1 , D}^{′} \\ {X}_{2 , 1}^{′} & {X}_{2 , 2}^{′} & … & {X}_{2 , D}^{′} \\ ⋮ & ⋮ & ⋮ & ⋮ \\ {X}_{l , 1}^{′} & {X}_{l , 2}^{′} & … & {X}_{l , D}^{′} \\ ⋮ & ⋮ & ⋮ & ⋮ \\ {X}_{N , 1}^{′} & {X}_{N , 2}^{′} & … & {X}_{N , D}^{′}\end{matrix} ]}_{N \times D} \qquad ( 8 )$$

where X′ represents an elite individual selected using the simulated annealing algorithm, and 1<l<N.

Step 106 specifically includes as follows.

The iterative process is divided into three stages, an update population is calculated by the corresponding calculation method, and the elite matrix is used to guide the parent population individuals to approach the elite individuals to generate a new child population. If it is at an initial stage of the iteration, the elite matrix is updated and guided using formula (10); if it is at an intermediate stage of the iteration, the population is divided into two parts, a first part is updated using formula (11), and a second part is updated using formula (12); if it is at a final stage of the iteration, the matrix is updated and guided using formula (14).

$$Iter < \frac{1}{3} {Iter}_{max} .$$

(1) At the initial stage of the iteration, an iteration number meets Iter is a current iteration number, and Iterₘₐₓ is a maximum iteration number of the algorithm. In this case, individuals in the population explore the solution space by Brown motion, and a rule for updating a step length is as follows:

$$\begin{matrix}{stepsize}_{i} = {R}_{B} ⊗ ( {Elite}_{i}^{′} - {R}_{B} ⊗ {P}_{i} ) \\ {P}_{i} = {P}_{i} + \frac{1}{2} \cdot R ⊗ {stepsize}_{i} \\ i = 1 , … , N\end{matrix} \qquad ( 9 )$$

where stepsizeᵢ is a next movement step of an i-th individual in the population, approaching the elite individual. R_{B} is a random number vector conforming to normal distribution based on Brown motion, and ⊗ is a multiplication operation item by item. R is a random vector uniformly distributed in [0,1].
(2) At the intermediate stage of the iteration, the iteration number meets:

$$\frac{1}{3} {Iter}_{max} < Iter < \frac{2}{3} {Iter}_{max} .$$

In this stage, the population is divided into two parts, and updated according to different rules.

First, for the first half of the population, the update rule is as following formula (10), where R_{L} is a random number vector based on Levy motion.

$$\begin{matrix}{stepsize}_{i} = {R}_{L} ⊗ ( {Elite}_{i}^{′} - {R}_{L} ⊗ {P}_{i} ) \\ {P}_{i} = {P}_{i} + \frac{1}{2} \cdot R ⊗ {stepsize}_{i} \\ i = 1 , … , \frac{N}{2}\end{matrix} \qquad ( 10 )$$

For the second half of the population, the update rule is as follows:

$$\begin{matrix}{stepsize}_{i} = {R}_{B} ⊗ ( {R}_{B} ⊗ {Elite}_{i}^{′} - {P}_{i} ) \\ {P}_{i} = {Elite}_{i}^{′} + \frac{1}{2} \cdot λ ⊗ {stepsize}_{i} \\ i = \frac{N}{2} , … , N\end{matrix} \qquad ( 11 )$$

where λ is a fitness parameter, the expression is:

$$λ = {( 1 - \frac{Iter}{{Iter}_{max}} )}^{( \frac{2 \cdot Iter}{{Iter}_{max}} )} . \qquad ( 12 )$$

(3) At the final stage of the iteration, the iteration number meets

$$Iter > \frac{2}{3} {Iter}_{max} .$$

The population update rule is as follows:

$$\begin{matrix}{stepsize}_{i} = {R}_{L} ⊗ ( {R}_{L} ⊗ {Elite}_{i}^{′} - {P}_{i} ) \\ {P}_{i} = {Elite}_{i}^{′} + \frac{1}{2} \cdot λ ⊗ {stepsize}_{i} \\ i = 1 , … , N\end{matrix} . \qquad ( 13 )$$

### Coding Sequence Discretization Stage:

After iterative optimization of the above algorithm, a lower-layer codes of the generated solution vector are continuous values. In order for the generated solution to apply to the discrete problem, the continuous values generated by the iteration must be converted to discrete values. First, the lower-layer data of the solution is normalized as follows:

$${X}_{i}^{norm} ( t ) = \frac{{X}_{i} ( t ) - {X}_{low}}{{X}_{up} - {X}_{low}} \qquad ( 14 )$$

where t is a current iteration number, Xᵢ^{norm}(t) is a value in [0,1], X_{low} is a lower bound of current solution, Xᵤₚ is the upper bound of the current solution.

A candidate set is constructed according to the corresponding coding bits of the sequence, and discrete values in the candidate set are sequenced and marked with serial numbers. A mapping relationship between normalized value and the candidate set as follows:

Xᵢ^{scal}=Xᵢ^{norm}(t)*(w−1)+1 (15)

where w is a number of optional devices in a candidate set of the production devices. A discrete solution vector can be obtained by rounding the result Xᵢ^{scal} to an index value in the corresponding candidate set. After obtaining the solution vector, it is necessary to check whether an upper-layer solution satisfies the constraint relationship. If not, the upper-layer constraint levels are sequenced, and the corresponding procedure coding position of the lower layer is translated and exchanged to meet the procedure process constraint. If numerical discrete conversion is required subsequently, this method is used for conversion.

Gaussian disturbance strategy is introduced to enhance a local search ability of the algorithm:

Pᵢ=Pᵢ⊗(1+λ·R_{G}) if r≤G (16)

where R_{G} is a random number vector conforming to the Gaussian distribution, and G=0.2 is a Gaussian disturbance probability. Gaussian disturbance is introduced to make the individuals in the population mutate and enhance a probability of jumping out of local optimum. The data generated by applying Gaussian disturbance strategy is still continuous value, so discrete transformation is needed to generate feasible solutions.

After many iterations, a current solution is obtained as an optimal solution, and a scheduling sequence is decoded as a scheduling scheme as an output. The coding bits of the procedure sequencing portion in the lower layer of the double-layer sequence are read from left to right in turn. According to the corresponding first half machine sequence and time sequence matrix, the processing machine and the processing time corresponding to each workpiece procedure are obtained in turn, and this procedure is sequenced, and then each procedure is processed on a processing machine selected in the procedure as early as possible. The sequence is decoded in turn in this manner until all procedures are arranged at earliest possible positions. Finally, a scheduling result is obtained, and a Gant diagram is drawn according to the scheduling result.

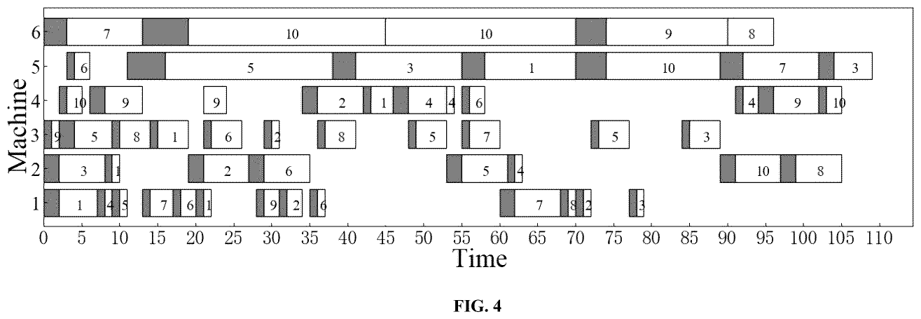

A corresponding scheduling scheme for a scheduling problem in the flexible assembly shop is represented by the Gant diagram, as shown in FIG. 4, and a maximum completion time is 109 minutes.

In conclusion, the multi-objective assembly shop scheduling method based on the heuristic optimization algorithm with multi-search fusion proposed by the present disclosure can be used in complex production scenarios with small batch, customization, complex production process and strong process constraint relationship, and the production efficiency is improved while the stability of the construction period is ensured.

Embodiment 2

In order to perform the method corresponding to the embodiment 1 described above to achieve corresponding functions and technical effects, a production task scheduling system for a flexible assembly job shop is provided below, including a compiling module, a sorting module, an elite matrix constructing module, an external archive constructing module, an updating module, an optimal scheduling scheme determining module, and a task scheduling module.

The compiling module is configured for compiling production processing data in a double-layer integer coding manner to obtain a double-layer code scheme, where upper-layer codes in the double-layer code scheme include a process type corresponding to workpiece machining and an assembly process constraint relationship, and lower-layer codes in the double-layer code scheme include machine assignment and procedure sequencing.

The sorting module is configured for sorting the lower-layer codes to generate an initialized population, where individuals in the initialized population all follow the assembly process constraint relationship.

The elite matrix constructing module is configured for calculating a fitness value of each individual in the population, selecting a solution with an optimal fitness value as an elite individual, and replicating the elite individual to construct an elite matrix.

The external archive constructing module, configured for constructing an external archive, where the external archive is used to store currently found non-dominant solutions.

The updating module is configured for selecting an excellent individual from all non-dominant solutions stored in the external archive as an optimal elite individual by using a simulated annealing algorithm, and updating the elite matrix through the optimal elite individual.

The optimal scheduling scheme determining module is configured for determining a final optimal elite individual as an optimal scheduling scheme based on an updated elitist matrix through using a three-stage heuristic optimization algorithm with multi-search fusion in an iterative process.

The task scheduling module is configured for scheduling production tasks in a flexible assembly job shop according to the optimal scheduling scheme.

### Embodiment 3

Embodiment 3 of the present disclosure provides an electronic device including a memory for storing a computer program and a processor for executing the computer program to cause the electronic device to perform the production task scheduling method for the flexible assembly job shop of Embodiment 1.

The above electronic device may be a server.

### Embodiment 4

Embodiment 4 of the present disclosure provides a computer-readable storage medium storing a computer program that, when executed by a processor, implements the production task scheduling method for the flexible assembly job shop of Embodiment 1.

Embodiments of the present specification are described in a progressive manner, each embodiment focuses on the difference from other embodiments, and the same and similar parts between the embodiments may refer to each other. Since the system disclosed in an embodiment corresponds to the method disclosed in another embodiment, the description is relatively simple, and reference can be made to the method description.

In this specification, some specific embodiments are used for illustration of principles and implementations of the present disclosure. The description of the foregoing embodiments is only used to help understand the method of the present disclosure and the core ideas thereof. The described embodiments are merely some rather than all of the embodiments of the present disclosure. All other embodiments obtained by those of ordinary skill in the art based on the embodiments of the present disclosure without creative efforts shall fall within the protection scope of the present disclosure.

What is claimed is:

1. A production task scheduling method for a flexible assembly job shop, comprising:
compiling production processing data in a double-layer integer coding manner to obtain a double-layer code scheme, wherein upper-layer codes in the double-layer code scheme comprise a process type corresponding to workpiece machining and an assembly process constraint relationship, and lower-layer codes in the double-layer code scheme comprise machine assignment and procedure sequencing;
sorting the lower-layer codes to generate an initialized population, wherein individuals in the initialized population all follow the assembly process constraint relationship;
calculating a fitness value of each individual in the population, selecting a solution with an optimal fitness value as an elite individual, and replicating the elite individual to construct an elite matrix;
constructing an external archive, wherein the external archive is used to store currently found non-dominant solutions;
selecting an excellent individual from all non-dominant solutions stored in the external archive as an optimal elite individual by using a simulated annealing algorithm, and updating the elite matrix through the optimal elite individual;
determining a final optimal elite individual as an optimal scheduling scheme based on an updated elitist matrix through using a three-stage heuristic optimization algorithm with multi-search fusion in an iterative process;
scheduling production tasks in a flexible assembly job shop according to the optimal scheduling scheme.

2. The method according to claim 1, wherein the lower-layer codes are sorted by a method combining global selection, local selection and random selection, to generate the initialized population.

3. The method according to claim 1, wherein after constructing the external archive, the method further comprises:
when it is determined that the external archive is currently overflowing, calculating crowding densities of the non-dominant solutions in the external archive, and replacing a non-dominant optimal solution with a highest crowding density through using a roulette algorithm.

4. The method according to claim 1, wherein at an initial stage of an iteration, the population is updated by Brown motion; at an intermediate stage of the iteration, a first half of the population is updated by Levy motion, and a second half of the population is updated by the Brown motion; at a final stage of the iteration, the population is updated by the Levy motion.

5. The method according to claim 1, further comprising adding a Gaussian disturbance in the iterative process.

6. A production task scheduling system for a flexible assembly job shop, comprising:
a compiling module, configured for compiling production processing data in a double-layer integer coding manner to obtain a double-layer code scheme, wherein upper-layer codes in the double-layer code scheme comprise a process type corresponding to workpiece machining and an assembly process constraint relationship, and lower-layer codes in the double-layer code scheme comprise machine assignment and procedure sequencing;
a sorting module, configured for sorting the lower-layer codes to generate an initialized population;
an elite matrix constructing module, configured for calculating a fitness value of each individual in the population, selecting a solution with an optimal fitness value as an elite individual, and replicating the elite individual to construct an elite matrix;
an external archive constructing module, configured for constructing an external archive, wherein the external archive is used to store currently found non-dominant solutions;
an updating module, configured for selecting an excellent individual from all non-dominant solutions stored in the external archive as an optimal elite individual by using a simulated annealing algorithm, and updating the elite matrix through the optimal elite individual;
an optimal scheduling scheme determining module, configured for determining a final optimal elite individual as an optimal scheduling scheme based on an updated elitist matrix through using a three-stage heuristic optimization algorithm with multi-search fusion in an iterative process;
a task scheduling module, configured for scheduling production tasks in a flexible assembly job shop according to the optimal scheduling scheme.

7. An electronic device comprising a memory for storing a computer program and a processor for executing the computer program to cause the electronic device to perform a production task scheduling method for a flexible assembly job shop, comprising:
compiling production processing data in a double-layer integer coding manner to obtain a double-layer code scheme, wherein upper-layer codes in the double-layer code scheme comprise a process type corresponding to workpiece machining and an assembly process constraint relationship, and lower-layer codes in the double-layer code scheme comprise machine assignment and procedure sequencing;
sorting the lower-layer codes to generate an initialized population, wherein individuals in the initialized population all follow the assembly process constraint relationship;
calculating a fitness value of each individual in the population, selecting a solution with an optimal fitness value as an elite individual, and replicating the elite individual to construct an elite matrix;
constructing an external archive, wherein the external archive is used to store currently found non-dominant solutions;
selecting an excellent individual from all non-dominant solutions stored in the external archive as an optimal elite individual by using a simulated annealing algorithm, and updating the elite matrix through the optimal elite individual;
determining a final optimal elite individual as an optimal scheduling scheme based on an updated elitist matrix through using a three-stage heuristic optimization algorithm with multi-search fusion in an iterative process;
scheduling production tasks in a flexible assembly job shop according to the optimal scheduling scheme.

8. The electronic device according to claim 7, wherein the lower-layer codes are sorted by a method combining global selection, local selection and random selection, to generate the initialized population.

9. The electronic device according to claim 7, wherein after constructing the external archive, the method further comprises:
when it is determined that the external archive is currently overflowing, calculating crowding densities of the non-dominant solutions in the external archive, and replacing a non-dominant optimal solution with a highest crowding density through using a roulette algorithm.

10. The electronic device according to claim 7, wherein at an initial stage of an iteration, the population is updated by Brown motion; at an intermediate stage of the iteration, a first half of the population is updated by Levy motion, and a second half of the population is updated by the Brown motion; at a final stage of the iteration, the population is updated by the Levy motion.

11. The electronic device according to claim 7, wherein the method further comprises adding a Gaussian disturbance in the iterative process.

12. A non-transitory computer-readable storage medium storing a computer program that, when executed by a processor, implements a production task scheduling method for a flexible assembly job shop, comprising:
compiling production processing data in a double-layer integer coding manner to obtain a double-layer code scheme, wherein upper-layer codes in the double-layer code scheme comprise a process type corresponding to workpiece machining and an assembly process constraint relationship, and lower-layer codes in the double-layer code scheme comprise machine assignment and procedure sequencing;
sorting the lower-layer codes to generate an initialized population, wherein individuals in the initialized population all follow the assembly process constraint relationship;
calculating a fitness value of each individual in the population, selecting a solution with an optimal fitness value as an elite individual, and replicating the elite individual to construct an elite matrix;
constructing an external archive, wherein the external archive is used to store currently found non-dominant solutions;
selecting an excellent individual from all non-dominant solutions stored in the external archive as an optimal elite individual by using a simulated annealing algorithm, and updating the elite matrix through the optimal elite individual;
determining a final optimal elite individual as an optimal scheduling scheme based on an updated elitist matrix through using a three-stage heuristic optimization algorithm with multi-search fusion in an iterative process;
scheduling production tasks in a flexible assembly job shop according to the optimal scheduling scheme.

13. The non-transitory computer-readable storage medium according to claim 12, wherein the lower-layer codes are sorted by a method combining global selection, local selection and random selection, to generate the initialized population.

14. The non-transitory computer-readable storage medium according to claim 12, wherein after constructing the external archive, the method further comprises:
when it is determined that the external archive is currently overflowing, calculating crowding densities of the non-dominant solutions in the external archive, and replacing a non-dominant optimal solution with a highest crowding density through using a roulette algorithm.

15. The non-transitory computer-readable storage medium according to claim 12, wherein at an initial stage of an iteration, the population is updated by Brown motion; at an intermediate stage of the iteration, a first half of the population is updated by Levy motion, and a second half of the population is updated by the Brown motion; at a final stage of the iteration, the population is updated by the Levy motion.

16. The non-transitory computer-readable storage medium according to claim 12, wherein the method further comprises adding a Gaussian disturbance in the iterative process.
